(19) United States
(12) Patent Application Publication
(10) Pub. No.: US 2026/0100507 A1
(43) Pub. Date: Apr. 9, 2026

(54) ANTENNA DEVICE

(71) Applicant: CANON KABUSHIKI KAISHA, Tokyo (JP)

(72) Inventor: KOSHI FUJITANI, Kanagawa (JP)

(21) Appl. No.: 19/346,832

(22) Filed: Oct. 1, 2025

(30) Foreign Application Priority Data
Oct. 9, 2024 (JP) 2024-177297

(51) Int. Cl. H01Q 5/25; H01Q 5/30; H01Q 9/04

(52) U.S. Cl. CPC H01Q 5/25; H01Q 5/30; H01Q 9/0407

(57) ABSTRACT

An antenna device comprises a ground conductor, a feed portion, a first conductor that is connected to the feed portion and operates in a first frequency band; and a second conductor that is separated from and electrically coupled with the first conductor and operates in a second frequency band, wherein the second conductor includes a grounding portion that is connected to the ground conductor and a proximity portion that is closest to the first conductor, and the second conductor includes a convex portion that is different from the grounding portion and the proximity portion and projects in a direction away from the first conductor.

### BACKGROUND

### Field of the Technology

The present disclosure relates to an antenna device for broadband communication.

### Description of the Related Art

In recent years, communication systems that enhance tracking and security by utilizing location information through ultra-wideband (UWB) wireless communication have attracted attention. Hardware responsible for UWB wireless communication needs to be configured to handle ultra-wideband signals, and antennas, as one of the hardware components, also need to be operated over ultra-wideband. Antennas mainly operate through resonance, and since the resonant structure of the antennas mainly depends on wavelength, the antenna size inevitably becomes large in order to cover a wide frequency range. Meanwhile, devices equipped with UWB have been miniaturized to a size that users can carry, and the antenna shape is required to be smaller.

Conventionally, antennas such as the one in Patent Document 1 are known as ultra-wideband antennas used in UWB. Japanese Patent Application Publication No. 2007-82037 realizes an antenna device for broadband transmission and reception of gigahertz (GHz) band radio waves by using a flat non-fed element in close proximity to two orthogonal sides constituting a planar antenna element, as viewed from the top side of the substrate.

### SUMMARY

The object of the present disclosure is to provide an antenna device that is compact and capable of operating over a broad bandwidth.

An antenna device according to one aspect of the present disclosure for achieving the above object is an antenna device comprising: a ground conductor; a feed portion; a first conductor that is connected to the feed portion and operates in a first frequency band; and a second conductor that is separated from and electrically coupled with the first conductor and operates in a second frequency band, wherein the second conductor includes a grounding portion that is connected to the ground conductor and a proximity portion that is closest to the first conductor, and the second conductor includes a convex portion that is different from the grounding portion and the proximity portion and projects in a direction away from the first conductor.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1A is a diagram illustrating an overall configuration of an antenna according to a first embodiment.

FIG. 1B is a diagram illustrating an overall configuration of the antenna according to the first embodiment.

FIG. 2 is a diagram illustrating dimensions of the antenna according to the first embodiment.

FIG. 3 is a diagram illustrating an electromagnetic field simulation result of the antenna according to the first embodiment.

FIG. 4A is a diagram illustrating a modification of the antenna according to the first embodiment.

FIG. 4B is a diagram illustrating a modification of the antenna according to the first embodiment.

FIG. 4C is a diagram illustrating a modification of the antenna according to the first embodiment.

FIG. 4D is a diagram illustrating a modification of the antenna according to the first embodiment.

FIG. 5 is a diagram illustrating a change in characteristics when a separation distance of the antenna according to the first embodiment is changed.

FIG. 6A is a diagram illustrating a design example that realizes miniaturization of the antenna according to the first embodiment.

FIG. 6B is a diagram illustrating a design example that realizes miniaturization of the antenna according to the first embodiment.

FIG. 7A is a diagram illustrating an overall configuration of an antenna according to a second embodiment.

FIG. 7B is a diagram illustrating an overall configuration of the antenna according to the second embodiment.

FIG. 8 is a diagram illustrating dimensions of the antenna according to the second embodiment.

FIG. 9A is a diagram illustrating an overall configuration of an antenna according to a third embodiment.

FIG. 9B is a diagram illustrating an overall configuration of the antenna according to the third embodiment.

FIG. 10 is a diagram illustrating dimensions of the antenna according to the third embodiment.

FIG. 11A is a diagram illustrating an overall configuration of an antenna according to a fourth embodiment.

FIG. 11B is a diagram illustrating an overall configuration of the antenna according to the fourth embodiment.

FIG. 12 is a diagram illustrating dimensions of the antenna according to the fourth embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

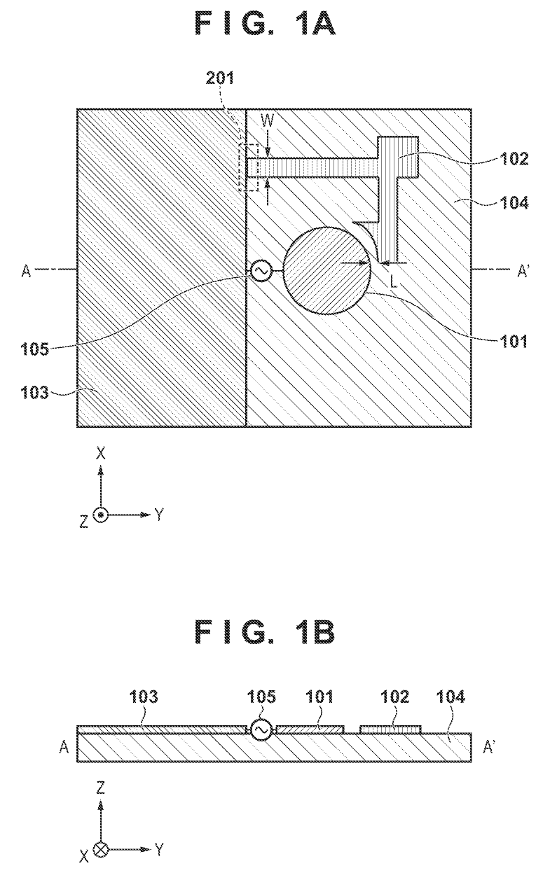

FIGS. 1A and 1B are diagrams of an overall configuration of an antenna device 1 according to the present embodiment. FIG. 1B illustrates a cross-sectional view of the antenna device 1 in a YZ plane along a dashed line A-A' of FIG. 1A.

The antenna device 1 comprises a first radiating element 101, a second radiating element 102, a ground 103, a dielectric 104, and a feed portion 105. In the present embodiment, it is assumed that the first radiating element 101 and the second radiating element 102 are arranged on the dielectric 104, and the ground 103 is also arranged on the same plane.

The first radiating element 101 is a fed element that includes a conductor (first conductor), with one end connected to the feed portion 105 and the other extending in a direction away from the ground 103 (+Y-axis direction in the drawing), then terminating in an open end. Here, the feed portion 105 can take the reference potential of an excitation signal from the ground 103. Further, the open end of the first radiating element 101 is in close proximity to the second radiating element 102. The first radiating element 101 is described as being disc-shaped in the example illustrated in FIG. 1A, but may have a polygonal shape. Further, although the first radiating element 101 is illustrated as a monopole antenna, it only needs to be capable of operating at a predetermined frequency (first frequency) when powered by the feed portion 105, and a patch antenna or a slot antenna may be used.

The feed portion 105 may be fed directly from, for example, a 50-Ω signal line (not illustrated) wired to the ground 103, or it may be powered from outside the antenna device 1 via, for example, a 50-Ω coaxial line (not illustrated) whose outer conductor is grounded to the ground 103. The feed portion 105 may take a transmission signal from a wireless communication circuit (not illustrated) as input, or the wireless communication circuit may receive a signal arriving from outside.

The second radiating element 102 is a non-fed element that includes a conductor connecting a grounding portion, which is grounded to the ground 103, and a proximity portion, which approaches the first radiating element 101. In the example of FIG. 1, it is illustrated as including a uniform-width linear conductor that extends in a direction away from the ground 103 (+Y-axis direction in the drawing), then bends and further extends in a direction approaching the first radiating element 101 (-X-axis direction in the drawing), but a tapered conductor may be used. At the extended end, it does not come into contact with the first radiating element 101 but approaches it in the Y-axis direction while remaining separated, thereby electromagnetically coupling with the first radiating element 101. It also includes a convex portion 203 that projects from the bend portion in another direction (+X-axis direction and +Y-axis direction), with a widened line width.

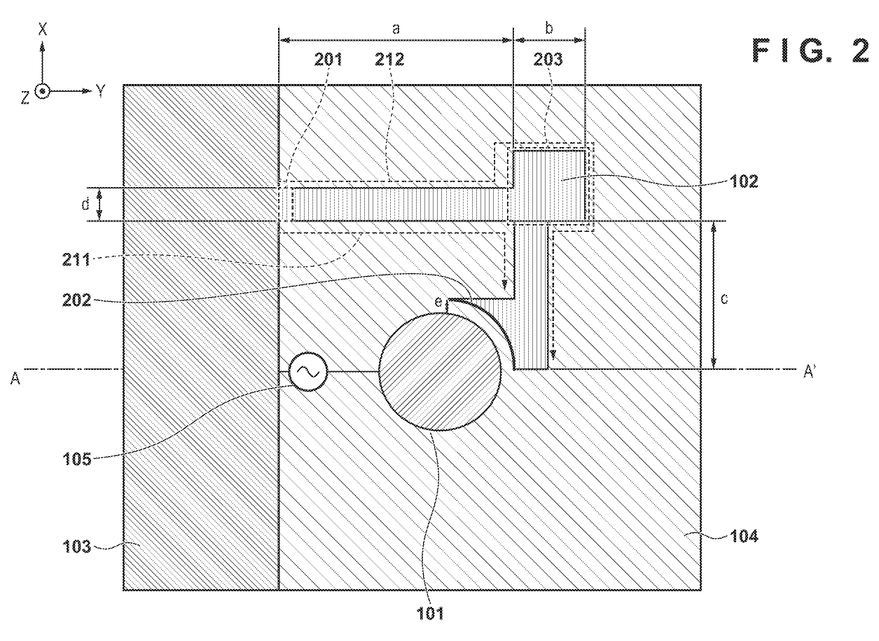

The convex portion 203 is an extending portion arranged to extend the open end in the +XY-axis direction, that is, in a direction away from the first radiating element 101. This makes it possible to increase the electrical length of the periphery portion (periphery portion 212 of FIG. 2) that is on the opposite side of the periphery portion (periphery portion 211 of FIG. 2) that faces the first radiating element 101, in the second radiating element 102. In other words, the convex portion 203 forms part of the longer periphery portion among the periphery portions that connect a grounding portion 201 and a proximity portion 202. This makes it possible to broaden the operating frequencies of the second radiating element 102 while suppressing an increase in its mounting area.

The second radiating element 102 has an element shape that allows adjustment of the resonant element length via the convex portion while maintaining electrical coupling with the first radiating element 101 in the Y-axis direction. In the present embodiment, a separation distance L between the first radiating element 101 and the opposing second radiating element 102 is shorter than a line width W where the second radiating element 102 is grounded to the ground 103.

Here, the feed portion 105 excites only the first radiating element 101 and the first radiating element 101 excites the second radiating element 102 through coupling at its open end side (in the +Y-axis direction in the drawing). The first radiating element 101 and the second radiating element 102 each exhibit physical resonance resulting from their structure. Therefore, the first radiating element 101, which has a shorter element length, resonates in a higher frequency band (first frequency band), and the second radiating element 102, which has a relatively longer element length than the first radiating element 101, resonates in a lower frequency band (second frequency band) than the first radiating element 101.

In order for the antenna device 1 to exhibit ultra-wideband resonance, the resonance frequency band of the first radiating element 101 and the resonance frequency band of the second radiating element 102 need to be combined such that they are continuous. Therefore, in the present embodiment, the shape of the first radiating element 101, as well as the shape of the convex portion of the second radiating element 102, and the shape of the region of the second radiating element 102 facing the first radiating element 101, including the proximity portion 202, may at least serve as design parameters.

Although the antenna device 1 illustrated in FIG. 1 is illustrated as being constituted by the dielectric 104 and conductors, additional elements may be added to shorten the element lengths while maintaining ultra-wideband resonance. For example, an inductor (not illustrated) may be inserted into the second radiating element 102. Further, in order to match the characteristic impedance with the feed portion 105, matching elements such as inductors and capacitors (not illustrated) may be inserted between the feed portion 105 and the first radiating element 101.

FIG. 2 is a diagram illustrating dimensions of the first radiating element 101, the second radiating element 102, and the ground 103 constituting the antenna device 1 in the present embodiment.

The first radiating element 101 is a disc-shaped element with a diameter of 3.5 mm. The second radiating element 102 includes the grounding portion 201 that connects to the ground 103, the proximity portion 202 that is coupled to the first radiating element 101 while remaining separated, and the convex portion 203 arranged on the conductor connecting the grounding portion 201 and the proximity portion 202. The grounding portion 201 and the proximity portion 202 are connected by a linear conductor with a width, and the convex portion 203 is arranged between the grounding portion 201 and the proximity portion 202 in the electrical path.

The grounding portion 201 is a linear conductor with a width that connects to the ground 103. Although the grounding portion 201 is illustrated as having a uniform width, it may have a tapered shape as will be described later in a second embodiment. The proximity portion 202 includes a point that is closest to the first radiating element 101, in the second radiating element 102.

For example, when the first radiating element 101 has a disc shape and an arc-shaped outer edge (first outer edge), the second radiating element 102 has an arc-shaped outer edge portion (second outer edge) that is concentric with the first radiating element 101, as illustrated in FIG. 2. Then, the proximity portion 202 is located at the arc-shaped outer edge portion. In one example, the arc-shaped outer edge portion of the second radiating element 102 is arranged so as to approach a point farthest from a point where the feed portion 105 connects to the first radiating element 101. In one example, the length of the second outer edge is greater than the line width of the grounding portion 201.

Further, as will be described later in modifications, when the first radiating element 101 has a triangular, rectangular or other polygonal shape, the proximity portion 202 of the second radiating element 102 is arranged to face a side opposite to a point where the feed portion 105 is connected.

In the present embodiment, the convex portion 203 is assumed to have a square shape. In the present embodiment, it is assumed that the grounding portion 201 and the proximity portion 202 are connected by a linear conductor having a bending portion, and the convex portion 203 is arranged at the bending portion. However, the grounding portion 201 and the proximity portion 202 may be connected by an arc-shaped conductor, in which case the convex portion 203 does not need to be arranged at the bending portion. Further, although the convex portion 203 is illustrated in the example of FIG. 2 as extending in both the X direction and the Y direction, it may extend only in either the X direction or the Y direction. Further, the convex portion 203 only needs to be a planar conductor having a circular, triangular, rectangular, or other polygonal shape, and is not limited to a square shape.

In the present embodiment, the dielectric 104, which constitutes the outer shape of a 30 mm × 44 mm substrate, is a Flame Retardant Type 4 (FR4) epoxy with a thickness of 1 mm in the Z-axis direction. Further, the ground 103, the first radiating element 101, and the second radiating element 102, which are provided on the front surface of the substrate in the +Z-axis direction, are copper thin films with a thickness of 35 μm in the Z-axis direction.

A length a of the second radiating element 102 extending in the +Y-axis direction from the ground 103 is 8 mm, and a length b of one side of the square constituting the convex portion in the +X-axis direction and the +Y-axis direction is 4 mm. Further, a length c of the second radiating element 102 extending in the -X-axis direction from the convex portion is 8.5 mm, a line width d of the grounding portion 201 that connects to the ground 103 is 1.5 mm. Further, a minimum separation distance e between the first radiating element 101 and the second radiating element 102 is 0.5 mm.

The ground 103 is assumed to have a sufficiently large electrical length at the frequency of the signal excited by the feed portion 105, and as one example, includes a conductor that is 30 mm on each of the four sides.

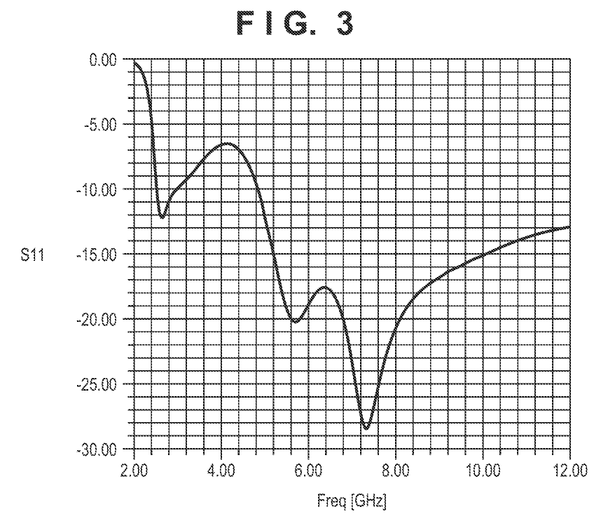

FIG. 3 illustrates results of analyzing the antenna device 1 illustrated in FIG. 2 using electromagnetic field simulation. In FIG. 3, the vertical axis indicates S11 [dB], which indicates a reflection characteristic, and the horizontal axis indicates frequency [GHz].

In the electromagnetic field simulation of FIG. 3, the reflection coefficient (S11) is -6 dB or below within the frequency range of 3.1 GHz to 10.6 GHz, which is allocated for ultra-wideband (UWB) communication by the Federal Communications Commission (FCC). Therefore, the antenna device resonates within the frequency band of 3.1 GHz to 10.6 GHz and can be used as an antenna device compliant with the IEEE 802.15.4z standard.

### Modification

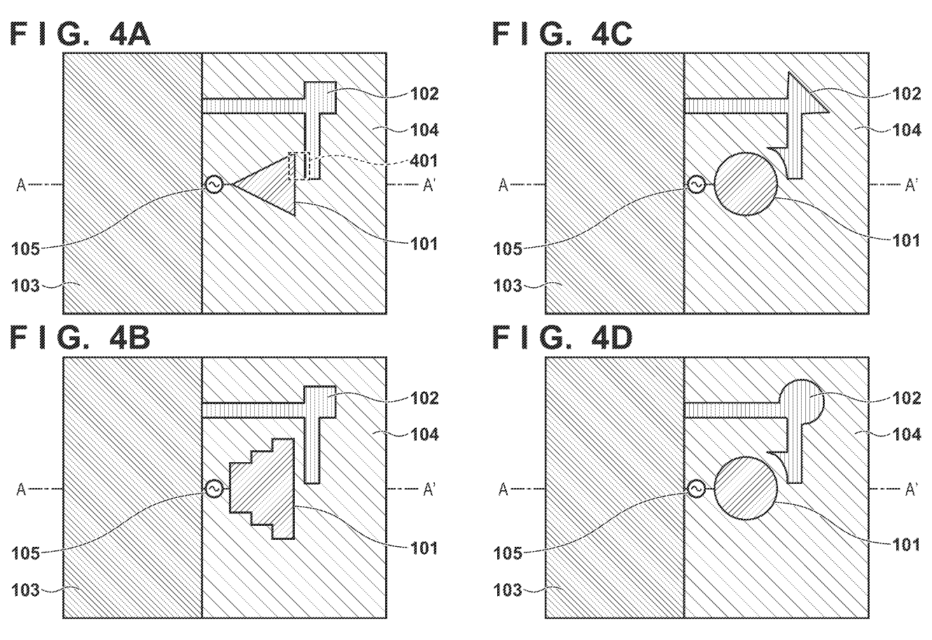

FIGS. 4A to 4D illustrate modifications 1 to 4 of the shapes that the first radiating element 101 and second radiating element 102 in the present embodiment may take.

The first radiating element 101 has a wide shape in the X-axis direction from the feed portion 105 toward the open end, which makes it possible to broaden the high-frequency side of the resonance frequencies among resonances obtained by the first radiating element 101. Therefore, the first radiating element 101 may have a polygonal shape such as a triangle (first modification illustrated in FIG. 4A) or a stepped shape (second modification illustrated in FIG. 4B), and similar to the case of a disc shape, the effect of broadening the high-frequency side of the resonance frequencies can be expected. In such cases, as illustrated in 401 in FIG. 4A, a portion of a side (second side) of the second radiating element 102 is arranged to face a side (first side) of the first conductor that is opposite to a point connected to the feed portion 105, and the second side operates as a proximity portion. In one example, the length of the second side is greater than the line width of the grounding portion of the second radiating element 102.

Further, the second radiating element 102 includes the convex portion 203 and thereby is responsible for broadening the low-frequency side of the resonance frequencies among the resonances obtained by the antenna device 1. Therefore, regarding the second radiating element 102, the convex portion 203 may have a shape in which at least the open end of the convex portion extends in the +X-axis and +Y-axis directions, such as a triangle (third modification illustrated in FIG. 4C) or a circle (fourth modification illustrated in FIG. 4D), and similar to the square, the effect of broadening the low-frequency side of resonances can be expected.

Further, the separation distance e of the first radiating element 101 and the second radiating element 102 only needs to be smaller than the line width d of the connection portion with the ground 103. If the separation distance e is too large, the strength of the coupling between the first radiating element 101 and the second radiating element 102 decreases, and the second radiating element 102 will no longer function as a parasitic element of the first radiating element 101. That is, it becomes impossible to connect the high-frequency side of resonances and the low-frequency side of resonances along the frequency axis by electrical coupling.

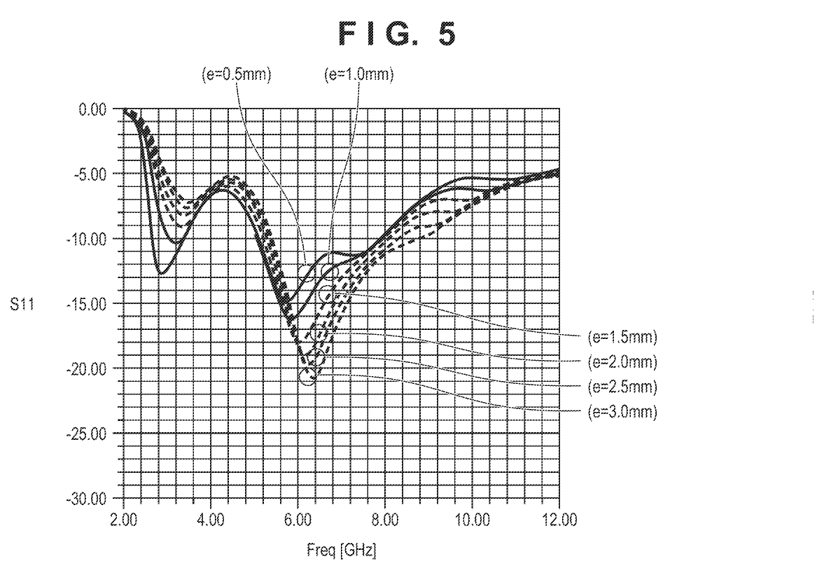

FIG. 5 illustrates results of analyzing the radiation characteristics the antenna device 1 using electromagnetic field simulation when the length of the separation distance e is changed. The length a of the conductors extending from the ground 103 in the +Y-axis direction is 8 mm, a side b of the square constituting the convex portion is 4 mm, a distance c extending from the convex portion in the -X-axis direction is 8.5 mm, and the line width d of the grounding portion 201 is 1.5 mm.

As illustrated in FIG. 5, it is indicated that when the separation distance e is increased 0.5 mm at a time, once it exceeds the line width b of 1.5 mm, the frequency bandwidth in which the first radiating element 101 and the second radiating element 102 achieve S11 of -6 dB or less within the UWB frequency range becomes narrow.

From the above, it can be seen that the first radiating element 101, which is a fed element of the antenna device 1, and the second radiating element 102, which is a non-fed element, each includes parameters that broaden the resonance bandwidth, and further, in combination, they include parameters that make the resonance frequencies continuous. Further, since the shape of the second radiating element 102, which includes the convex portion 203, and the shape of the first radiating element 101 can be flexibly changed, it can be seen that the antenna device is one with a high degree of design freedom.

The combination of shapes of the fed element and non-fed element illustrated in FIGS. 2 and 4A to 4D is not limited. For example, a disc-shaped first radiating element 101 may be combined with the second radiating element 102 illustrated in FIGS. 4A or 4B.

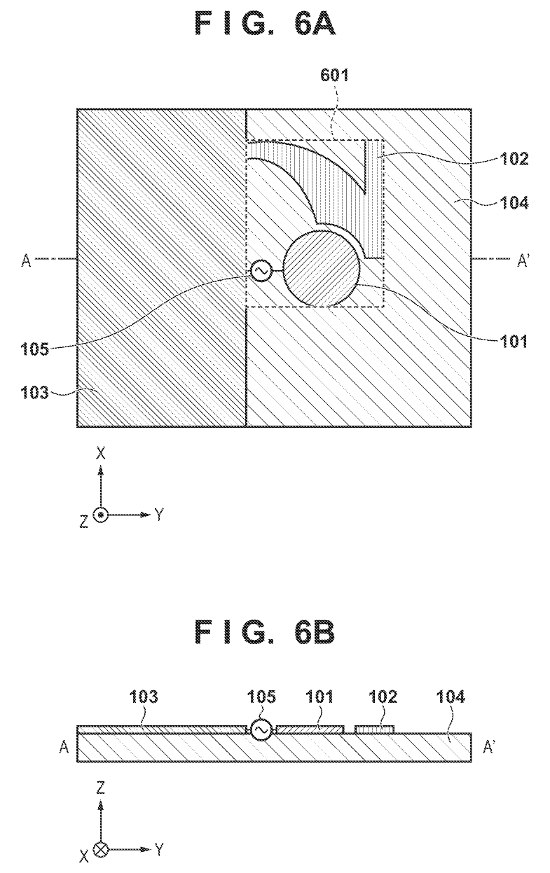

FIGS. 6A and 6B are a design example of an antenna that has been miniaturized while maintaining ultra-wideband resonance compared to the antenna shape of FIG. 1. In the example of FIGS. 6A and 6B, the second radiating element 102 has a shape that includes an arc that is concentric with the disc of the first radiating element 101. In other words, the second conductor that connects the grounding portion and the coupling portion of the second radiating element 102 has an arc shape, and the convex portion includes a linear conductor with a width. Further, by orienting the open end of the convex portion in the +X-axis direction, it is possible to increase the electrical length of the periphery portion that is on the opposite side of the periphery portion that faces the first radiating element 101, in the second radiating element 102. In one example, the line width of the linear conductor of the convex portion is greater than the line width of the grounding portion. Furthermore, by making the arc-shaped outer edge of the second radiating element 102, which includes the proximity portion 202, face a wide portion of the arc-shaped outer edge constituting the circular first radiating element 101 at an equal distance, it is possible to increase the coupling strength between the proximity portion 202 and the first radiating element 101. This makes it possible to design a compact antenna that fits within a 13.5 mm × 9.5 mm region as an antenna region 601, while satisfying the UWB frequency range. Since UWB-equipped devices are expected to be miniaturized as portable devices, reducing the mounting area of the antenna device can be an advantageous design aspect for implementation.

As described above, the antenna device according to the present embodiment includes the first radiating element, which is connected to the feed portion, and the second radiating element, which is connected to the ground and is separated from and electromagnetically coupled to the first radiating element. In addition, the convex portion that projects in a direction away from the first radiating element is arranged on a conductor that connects the proximity portion, which is closest to the first radiating element, and the grounding portion, which is connected to the ground, in the second radiating element.

Regarding conventional antennas, the two constituting radiating elements are each formed in a straight line, the plate-shaped non-fed element, which is a non-fed element, extends only in a direction approaching the plate-shaped antenna element, which is a fed element. Further, in order to adjust the resonance frequency under constraints on the surface area for placing the antenna, it is necessary to extend the open end side of the plate-shaped non-fed element, making it difficult to achieve both miniaturization of the antenna device and broadband of the antenna device.

However, in the antenna of the present disclosure, it is possible to broaden the operating frequencies of the antenna device by broadening the resonance frequencies of the second radiating element, while realizing miniaturization of the antenna device.

### Second Embodiment

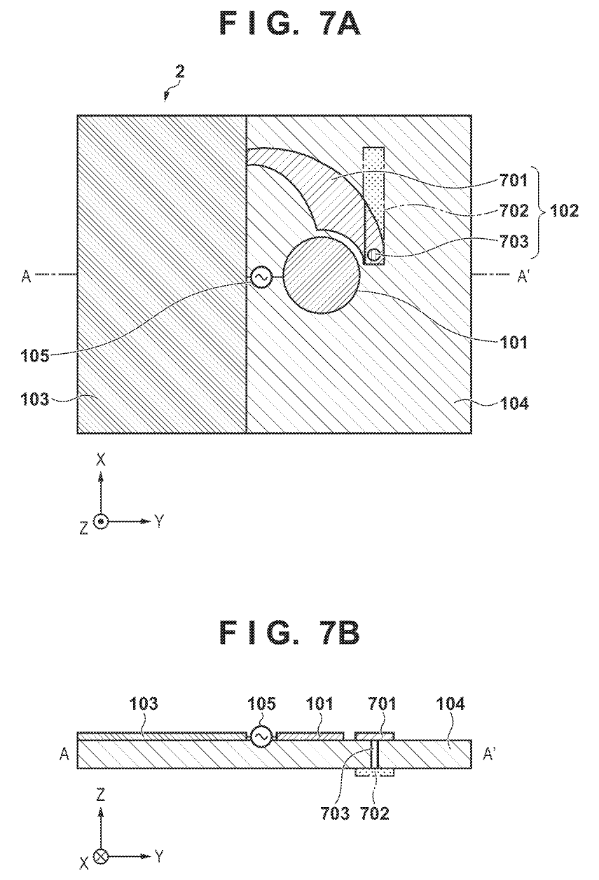

FIGS. 7A and 7B are diagrams of an overall configuration of an antenna device 2 including a second radiating element arranged on a plurality of layers of the substrate. FIG. 7A illustrates a top view of the antenna device 2 in an XY plane, and FIG. 7B illustrates a cross-sectional view of the antenna device 2 along a dashed line A-A' of FIG. 7A. Regarding structures and dimensions similar to those of the first and second embodiments, the same reference numerals are used, and descriptions are omitted.

The antenna device 2 includes the second radiating element 102 (which includes a conductor 701 on a first layer, a conductor 702 on a second layer, and a via 703), the first radiating element 101, the ground 103, the dielectric 104, and the feed portion 105, and resonates in 3.1 GHz to 10.6 GHz.

The first radiating element 101 and the conductor 701 are arranged on the first layer, which corresponds to the front surface of the substrate constituted by the dielectric 104, and the ground 103 is also arranged on the same plane. The conductor 702 is arranged in a second layer parallel to the first layer of the dielectric 104. In one example, the first layer is the front surface of the substrate and the second layer is the back surface of the substrate.

The first radiating element 101 is a fed element with one end connected to the feed portion 105 and the other extending in a direction away from the ground 103 (+Y-axis direction in the drawing), then terminating in an open end. Here, the feed portion 105 can take the reference potential of an excitation signal from the ground 103. Further, the open end of the first radiating element 101 is in close proximity to the conductor 701 of the second radiating element 102. The first radiating element 101 has, for example, a disc shape as illustrated in FIG. 7A.

The conductor 701 of the second radiating element 102 is grounded at one end to the ground 103, and extends in a direction away from the ground 103 (in the -X-axis direction and the +Y-axis direction in the drawing) at the other end. At the extended end, it approaches the first radiating element 101 in the X-axis direction and the Y-axis direction while remaining separated. Further, the second radiating element 102 includes the conductor 702 (corresponding to the conductor of the convex portion) that extends in another direction (+X-axis direction) from the open end of the conductor 701 via the via 703 that penetrates the dielectric 104 in the Z-axis direction.

That is, the conductor 701 has an element shape that allows the resonant element length to be variable via the conductor 702, while ensuring electrical coupling with the first radiating element 101 in the X-axis direction and the Y-axis direction. Here, the separation distance between the radiating element 101 and the opposing conductor 701 is shorter than the line width where the conductor 701 is grounded to the ground 103. The via 703 may be an interlayer via, in which case the conductor 702 may be provided in an intermediate layer of the substrate.

Similarly to the first embodiment, the feed portion 105 excites only the first radiating element 101 and the first radiating element 101 excites the conductor 701 through coupling at its open end side (in the +Y-axis direction in the drawing). The first radiating element 101 and the second radiating element 102 (which is constituted by the conductor 701, the via 703, and the conductor 702) each exhibit physical resonance resulting from their structure. Therefore, the first radiating element 101, which has a shorter element length, resonates in a higher frequency, and the second radiating element 102, which has a relatively longer element length than the first radiating element 101, resonates in a lower frequency than the first radiating element 101.

In order for the antenna device 2 to exhibit ultra-wideband resonance, the resonance frequency band of the first radiating element 101 and the resonance frequency band of the second radiating element 102 need to be combined such that they are continuous. Therefore, the shape of the first radiating element 101, as well as the shape of the conductor 701 facing the first radiating element 101 and the shape of the conductor 702 in the second radiating element 102 may at least serve as design parameters of the antenna device 2.

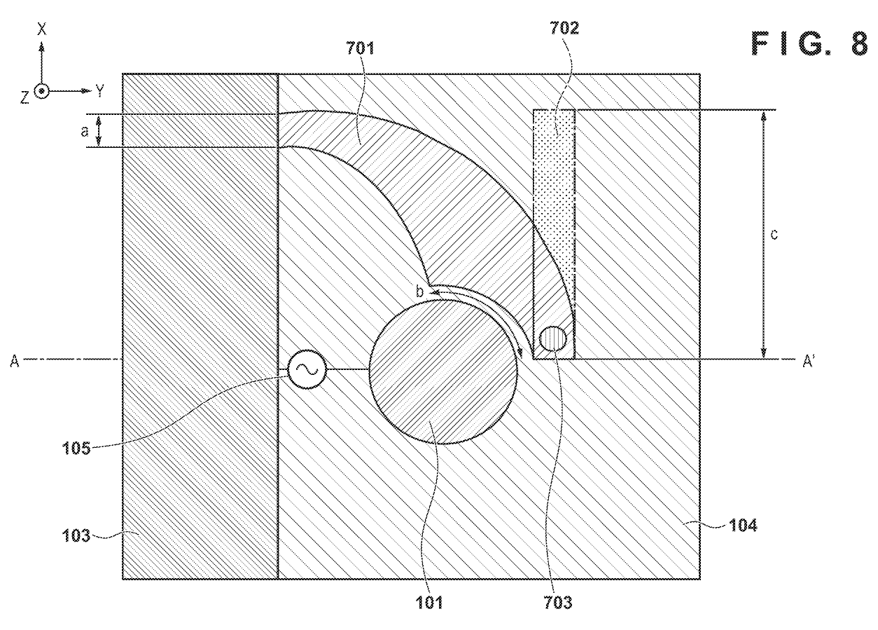

FIG. 8 is a diagram illustrating dimensions of the first radiating element 101, the conductor 701, the via 703, the conductor 702, and the ground 103 constituting the antenna device 2 according to the present embodiment.

The dielectric 104, which constitutes the outer shape of a 30 mm × 44 mm substrate, is an FR4-epoxy with a thickness of 1 mm in the Z-axis direction. The ground 103, the first radiating element 101, and the conductor 701, which are provided on the front surface of the substrate in the +Z-axis direction, are copper thin films with a thickness of 35 μm in the Z-axis direction. Further, the conductor 702, which is provided on the back surface of the substrate in the -Z-axis direction, is a copper thin film with a thickness of 35 μm in the Z-axis direction. The first radiating element 101 is a disc-shaped conductor with a diameter of 3.5 mm.

The conductor 701 of the second radiating element 102 is a linear element that extends from the ground 103 in the -X-axis direction and the +Y-axis direction, has a distance b along an arc facing the first radiating element 101 is about 5.2 mm, and has a line width a of 1.5 mm where it connects to the ground 103.

The conductor 702 of the second radiating element 102 extends from the via 703 in the +X-axis direction for a distance c of 9 mm, and the via 703 has a cylindrical shape with a diameter of 0.8 mm and a height of 1 mm. Here, a separation distance between the first radiating element 101 and the conductor 701 of the second radiating element 102 is 0.5 mm.

The ground 103 is assumed to have a sufficiently large electrical length at the frequency of the signal excited by the feed portion 105, and as one example, is 30 mm on each of the four sides.

By connecting the conductor 701 and the conductor 702 with the via 703, the electrical length of the second radiating element 102 can be further increased by the length of the via, making it possible to broaden the low-frequency side of the resonance frequency band while maintaining the antenna size, as viewed from the substrate thickness direction (Z-axis direction). In other words, miniaturization of the antenna can be achieved while maintaining the resonance frequency obtained by the antenna device 2.

Further, when the antenna is implemented in a device, the antenna characteristics may vary if metal components (not illustrated), a resin casing (not illustrated), a human body (not illustrated), or the like are in close proximity to the vicinity of the first radiating element 101. However, by placing only the conductor 702 on the back surface of the substrate through the via 703, the conductor 702 can be distanced in the Z-axis direction from metal components mounted on the front surface of the substrate, resin, the human body, and the like. Therefore, when the Specific Absorption Rate (SAR), antenna performance, and the like of the antenna device 2 are affected due to coupling between the conductor 702 and the above metal components, resin, or human body (which are different from the antenna device 2), improvement in the characteristics can be expected.

### Third Embodiment

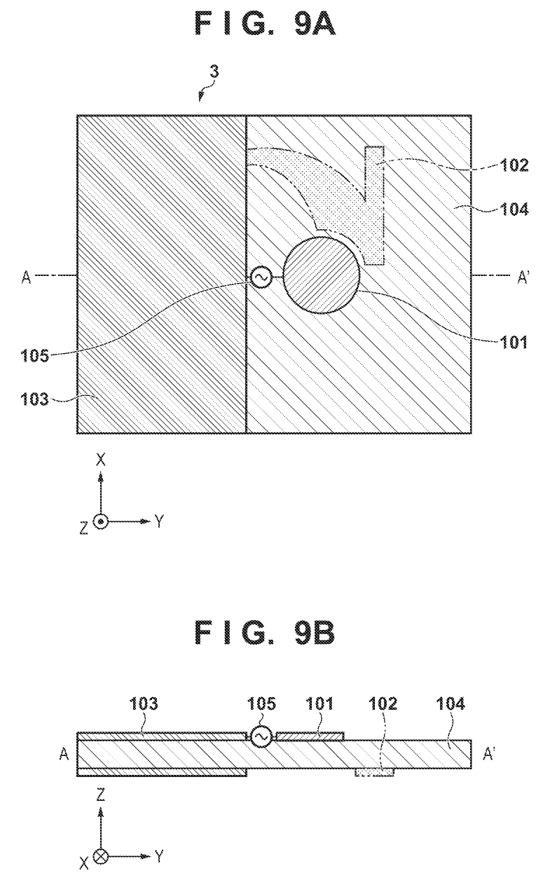

FIGS. 9A and 9B illustrate diagrams of an overall configuration of an antenna device 3 in which the second radiating element is arranged on the back surface of the substrate. Regarding structures and dimensions similar to those of the first and second embodiments, the same reference numerals are used, and descriptions are omitted.

FIG. 9B is a cross-sectional view of the antenna device 3 in a YZ plane along a dashed line A-A' of FIG. 9A.

The antenna device 3 includes the first radiating element 101, the second radiating element 102, the ground 103, the dielectric 104, and the feed portion 105, and resonates within the frequency band of 3.1 GHz to 10.6 GHz.

The first radiating element 101 is arranged on the first layer, which corresponds to the front surface of the substrate constituted by the dielectric 104, and the ground 103 is also arranged on the same plane. The second radiating element 102 is arranged on the second layer, which corresponds to the back surface of the substrate constituted by the dielectric 104, and the ground 103 is also arranged on the same plane. That is, the ground 103 is on the front surface and the back surface of the substrate and is maintained at the same potential by a ground via (not illustrated) or the like.

The first radiating element 101 is a fed element with one end connected to the feed portion 105 and the other extending in a direction away from the ground 103 (+Y-axis direction in the drawing), then terminating in an open end. Here, the feed portion 105 can take the reference potential of an excitation signal from the ground 103. Further, the open end of the first radiating element 101 is in close proximity to the second radiating element 102. The first radiating element 101 has, for example, a disc shape as illustrated in FIG. 9A.

The second radiating element 102 includes a grounding portion connected to the ground 103 at one end, and extends in a direction away from the ground 103 (in the -X-axis direction and the +Y-axis direction in the drawing) at the other end. At the extended end, it couples with the first radiating element 101 in the X-axis direction and the Y-axis direction while remaining separated. It also includes a convex portion (corresponding to the conductor of the convex portion) that extends in another direction (+X-axis direction) in a shape in which it folds back from the open end in close proximity to the first radiating element 101. Here, when viewed from the substrate thickness direction (Z-axis direction), the first radiating element 101 and the second radiating element 102 do not overlap.

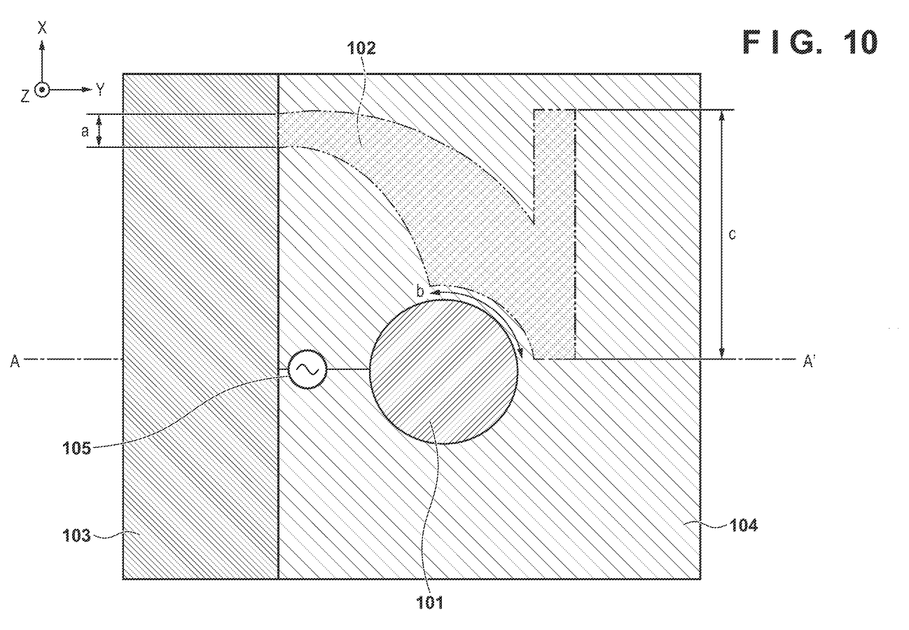

FIG. 10 is a diagram illustrating various dimensions of the antenna device illustrated in FIGS. 9A and 9B.

The dielectric, which constitutes the outer shape of a 30 mm × 44 mm substrate, is an FR4-epoxy with a thickness of 1 mm in the Z-axis direction, and the ground 103 and the first radiating element 101, which are provided on the front surface of the substrate in the +Z-axis direction, are copper thin films with a thickness of 35 μm in the Z-axis direction. Further, the second radiating element 102, which is provided on the back surface of the substrate in the -Z-axis direction, is a copper thin film with a thickness of 35 μm in the Z-axis direction.

The first radiating element 101 is a disc-shaped conductor with a diameter of 3.5 mm. The second radiating element 102 is a linear element that extends from the ground 103 in the -X-axis direction and the +Y-axis direction, has a distance b along an arc facing the first radiating element 101 is about 5.2 mm, and has a line width a of 1.5 mm where it connects to the ground 103. The second radiating element 102 extends in the +X-axis direction for a distance c of 9 mm.

Here, the separation distance between the first radiating element 101 and the second radiating element 102 is 0.5 mm when viewed from the substrate thickness direction (Z-axis direction), and is 1 mm in the substrate thickness direction (Z-axis direction). The ground 103 is assumed to have a sufficiently large electrical length at the frequency of the signal excited by the feed portion 105, and as one example, is 30 mm on each of the four sides.

As described above, the antenna device according to the present embodiment includes the first radiating element (which is a fed element arranged on the first layer), the second radiating element (which is a non-fed conductor arranged on the second layer), and a ground conductor arranged on the first and second layers. Further, the second radiating element includes the convex portion extending in a direction away from the first radiating element. This makes it possible to broaden the bandwidth of the second radiating element.

### Fourth Embodiment

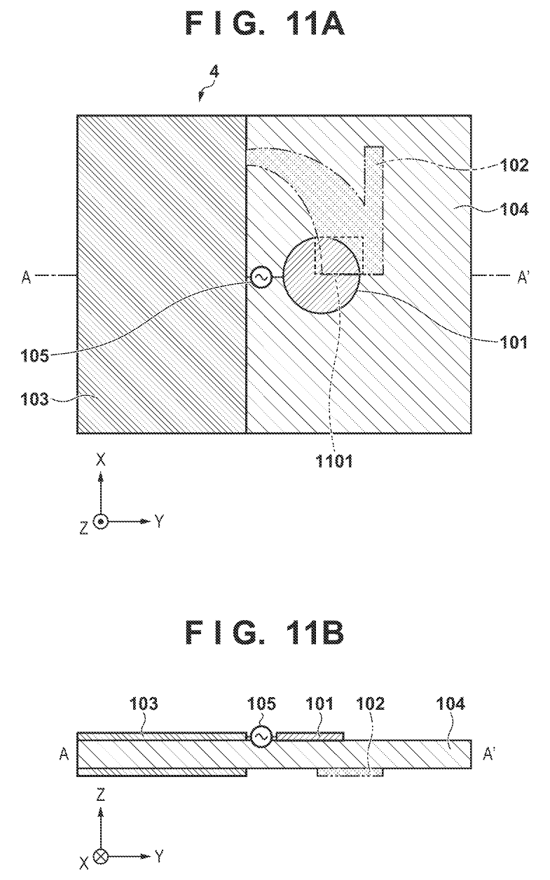

FIGS. 11A and 11B illustrate an antenna device 4 in which the second radiating element is arranged on the back surface of the substrate. FIG. 11B is a cross-sectional view of the antenna device 4 in a YZ plane along a dashed line A-A' of FIG. 11A.

The antenna device 4 includes the first radiating element 101, the second radiating element 102, the ground 103, the dielectric 104, and the feed portion 105, and resonates within the frequency band of 3.1 GHz to 10.6 GHz. The first radiating element 101 is arranged on the first layer, which corresponds to the front surface of the substrate constituted by the dielectric 104, and the ground 103 is also arranged on the same plane. The second radiating element 102 is arranged on the second layer, which corresponds to the back surface of the substrate constituted by the dielectric 104, and the ground 103 is also arranged on the same plane. That is, the ground 103 is arranged on the front surface and the back surface of the substrate and is maintained at the same potential by being connected by a ground via (not illustrated) or the like.

The first radiating element 101 is a fed element with one end connected to the feed portion 105 and the other extending in a direction away from the ground 103 (+Y-axis direction in the drawing), then terminating in an open end. Here, the feed portion 105 can take the reference potential of an excitation signal from the ground 103. Further, the open end of the first radiating element 101 is in close proximity to the second radiating element 102. The first radiating element 101 has, for example, a disc shape as illustrated in FIG. 9A.

The second radiating element 102 is grounded at one end to the ground 103, and extends in a direction away from the ground 103 (in the -X-axis direction and the +Y-axis direction in the drawing) at the other end. At the extended end, it approaches the first radiating element 101 in the X-axis direction and the Y-axis direction while remaining separated. The second radiating element 102 also includes a convex portion (corresponding to the conductor of the convex portion) that extends in another direction (+X-axis direction) away from the first radiating element 101 in a shape in which it folds back from the open end in close proximity to the first radiating element 101. Here, when viewed from the substrate thickness direction (Z-axis direction), respective portions of the first radiating element 101 and the second radiating element 102 overlap in a region 1101. In other words, in the antenna device 4 according to the present embodiment, the separation distance between the first radiating element 101 and the second radiating element 102 is the thickness of the substrate, and the proximity portion is located in the region 1101.

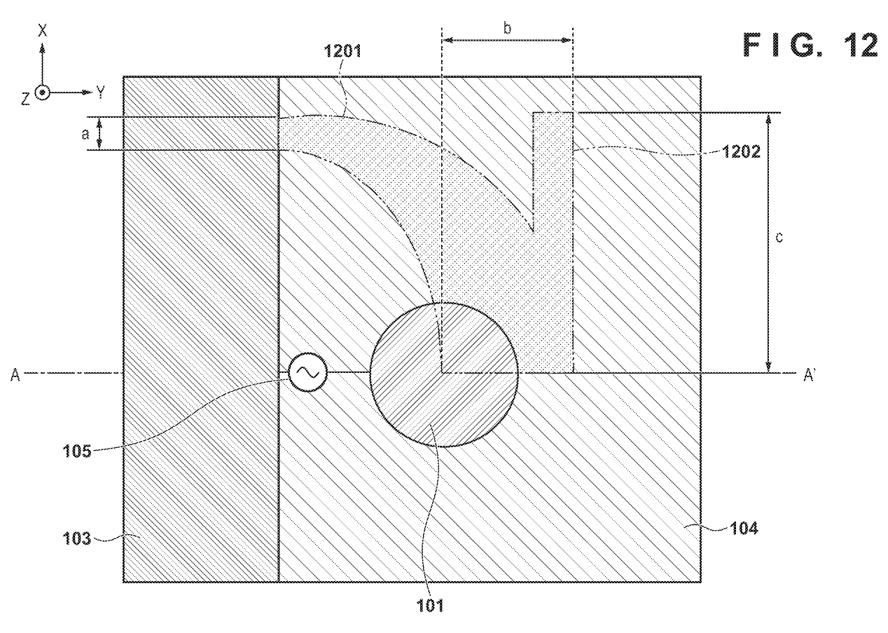

FIG. 12 is a diagram illustrating various dimensions in FIG. 11. The dielectric, which constitutes the outer shape of a 30 mm × 44 mm substrate, is an FR4-epoxy with a thickness of 1 mm in the Z-axis direction, and the ground 103 and the first radiating element 101, which are provided on the front surface of the substrate in the +Z-axis direction, are copper thin films with a thickness of 35 μm in the Z-axis direction. Further, the second radiating element 102, which is provided on the back surface of the substrate in the -Z-axis direction, is a copper thin film with a thickness of 35 μm in the Z-axis direction.

The first radiating element 101 is a disc-shaped conductor with a diameter of 3.5 mm. The second radiating element 102 is a linear element that extends from the ground 103 in the -X-axis direction and the +Y-axis direction, has an open end facing the first radiating element 101 with a distance b of about 4 mm in the Y-axis direction, and has a line width a of 1.5 mm where it connects to the ground 103. The second radiating element 102 extends in the +X-axis direction for a distance c of 9 mm. Here, the separation distance between the first radiating element 101 and the second radiating element 102 is 1 mm in the substrate thickness direction (Z-axis direction).

The ground 103 is assumed to have a sufficiently large electrical length at the frequency of the signal excited by the feed portion 105, and as one example, is 30 mm on each of the four sides. By arranging the first radiating element 101, which is a fed element, and the second radiating element 102, which is a non-fed element, on different layers of the substrate, the design freedom is increased. Furthermore, by arranging the first radiating element 101 and the second radiating element 102 such that the surfaces face each other across the substrate, electrical coupling can be enhanced. This makes it possible to broaden the low-frequency side of the resonance frequency bandwidth while maintaining the antenna size, as viewed from the substrate thickness direction (Z-axis direction). In other words, miniaturization of the antenna can be achieved while maintaining the obtained resonance frequency.

### Other Embodiments

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-177297, filed October 9, 2024, which is hereby incorporated by reference herein in its entirety.

What is claimed is:

1. An antenna device comprising:
a ground conductor;
a feed portion;
a first conductor that is connected to the feed portion and operates in a first frequency band; and
a second conductor that is separated from and electrically coupled with the first conductor and operates in a second frequency band,
wherein
the second conductor includes a grounding portion that is connected to the ground conductor and a proximity portion that is closest to the first conductor, and
the second conductor includes a convex portion that is different from the grounding portion and the proximity portion and projects in a direction away from the first conductor.

2. The antenna device according to claim 1, wherein
the second conductor includes a linear conductor that has a uniform width or is tapered at the grounding portion, and
a minimum separation distance between the first conductor and the proximity portion is smaller than a line width of the second conductor at the grounding portion.

3. The antenna device according to claim 1, wherein
the first frequency band is higher in frequency than the second frequency band.

4. The antenna device according to claim 1, wherein
the second conductor
includes a linear conductor that connects the grounding portion and an open end and has a width, and
includes a first periphery portion that is close to the first conductor and connects the grounding portion and the proximity portion,
a second periphery portion that connects the grounding portion and the proximity portion and is longer than the first periphery portion, and
the convex portion forms the second periphery portion.

5. The antenna device according to claim 4, wherein
the linear conductor of the second conductor includes a bending portion, and the convex portion is arranged in the bending portion.

6. The antenna device according to claim 1, wherein
the first conductor includes a polygonal conductor,
the second conductor includes a second side facing at least a portion of a first side of the first conductor, the first side being opposite to a point where the feed portion is connected, and
the proximity portion of the second conductor is included in the second side.

7. The antenna device according to claim 6, wherein
a length of the second side is greater than a line width of the grounding portion.

8. The antenna device according to claim 1, wherein
the first conductor includes an arc-shaped first outer edge,
the second conductor includes an arc-shaped second outer edge that is concentric with the first outer edge, and
the proximity portion of the second conductor is included in the second outer edge.

9. The antenna device according to claim 8, wherein
the first outer edge includes a point farthest away from a point where the feed portion is connected in the first conductor.

10. The antenna device according to claim 8, wherein
a length of the second outer edge is greater than a line width of the grounding portion.

11. The antenna device according to claim 1, further comprising:
a substrate including a first surface and a second surface parallel to the first surface,
wherein
the first conductor and the ground conductor are arranged on the first surface, and
the convex portion is arranged on the second surface.

12. The antenna device according to claim 1, further comprising:
a substrate including a first surface and a second surface parallel to the first surface,
wherein
the proximity portion is arranged on the second surface, and
when viewed in a thickness direction of the substrate, the proximity portion and at least a portion of the first conductor overlap.

13. The antenna device according to claim 1, wherein
the convex portion includes a circular, rectangular, or triangular, planar conductor whose portion overlaps with a linear conductor or a tapered conductor that connects the grounding portion and an open end of the second conductor.

14. The antenna device according to claim 1, wherein
the convex portion includes a rectangular, planar conductor, and a width of the convex portion is greater than a width of the grounding portion.
